(19) United States
(12) Patent Application Publication
(10) Pub. No.: US 2006/0160539 A1
(43) Pub. Date: Jul. 20, 2006

(54) Handoff control methods and related devices

(75) Inventors: Hung-Hui Juan, Taipei City (TW); Ching-Yao Huang, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/320,245

(22) Filed: Dec. 28, 2005

(30) Foreign Application Priority Data
Jan. 18, 2005 (TW) 094101401

(51) Int. Cl. H04Q 7/20

(52) U.S. Cl. 455/436

(57) ABSTRACT

Handoff control methods. User equipment measures the strength of a first pilot signal in an active set. The first pilot signal is transmitted from a base station currently providing services to the user equipment. Handoff parameters for handoff are dynamically set according to the strength of the first pilot signal, and handoff thresholds are determined corresponding to the handoff parameters. If the total strength of other pilot signals other than the first pilot signal in the active set is below a predetermined value, the handoff parameters are further adjusted.

### BACKGROUND

The present disclosure relates generally to communication management, and, more particularly, to handoff control methods and related devices.

In a 3G communication system, such as a UMTS (Universal Mobile Telecommunication System), UE (User Equipment), such as a mobile phone, measures pilot signal strength in CPICH (Common Pilot Channel). After the pilot strength is known, UE determines whether to add the pilot to an active set, and perform a soft handoff. If so, communication service for the UE is provided by a new base station.

Since diversity gain can be obtained during the soft handoff, and the diversity gain decreases transmission power of UE in uplink, the total interference in uplink is decreased. Therefore, better connection quality can be provided by soft handoff. Additionally, since UE can communicate with more than one base station during soft handoff, UE can get better aggregate pilot strength (aggregate Ec/Io), implying better connection quality.

FIG. 1 is a schematic diagram illustrating handoff thresholds of a conventional UMTS. The handoff thresholds comprise an add threshold (Tr_add) and a drop threshold (Tr_drop). If the strength of a pilot signal of a base station not in the active set exceeds the add threshold for a predetermined time, the base station is added to the active set. If the strength of a pilot signal of a base station in the active set is below the drop threshold for a predetermined time, the base station is removed from the active set. Additionally, the handoff thresholds further comprise a swap threshold (Tr_swap) (not shown in FIG. 1). If the active set is full, and the strength of a pilot signal of a base station not in the active set exceeds the swap threshold for a predetermined time, the base station is added to the active set, and the base station having the weakest pilot strength is removed therefrom.

UE, however, uses more system resources and capacity during a soft handoff. The downlink total interference increases as more base stations transmit power to UE. Other UE in the communication system experience interference and decreased connection quality (aggregate pilot strength) due to the rising downlink total interference. With the decrease of connection quality (the best pilot strength is decreased), and the handoff thresholds are also decreased, as shown in FIG. 1, resulting in unnecessary soft handoffs. Therefore, during a soft handoff, it is critical to ensure the handoff is useful and does not impact the connection quality of other UE.

### SUMMARY

Handoff control methods and related devices are provided.

In an exemplary embodiment of a handoff control method, user equipment measures the strength of a first pilot signal in an active set. The first pilot signal is transmitted from a base station currently providing services to the user equipment. Handoff parameters for handoff are dynamically set according to the strength of the first pilot signal, and handoff thresholds are determined corresponding to the handoff parameters.

If the total strength of other pilot signals other than the first pilot signal in the active set is below a predetermined value, the handoff parameters are further adjusted.

Handoff control methods may take the form of program code embodied in tangible media. When the program code is loaded into and executed by a machine, the machine becomes an apparatus for practicing the disclosed method.

### DESCRIPTION OF THE DRAWINGS

The invention will become more fully understood by referring to the following detailed description with reference to the accompanying drawings, wherein:

FIG. 1 is a schematic diagram illustrating handoff thresholds of a conventional UMTS;

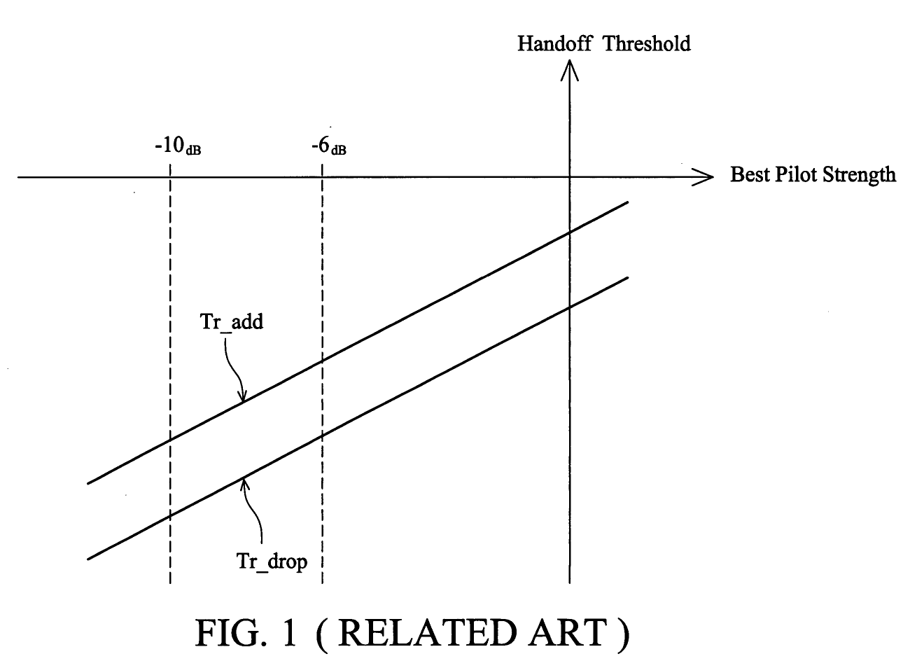

FIG. 2 is a schematic diagram illustrating an embodiment of user equipment;

FIG. 3 is a flowchart of an embodiment of a method for setting handoff thresholds;

FIG. 4 is a flowchart of an embodiment of a handoff method;

FIG. 5 is a schematic diagram illustrating an embodiment of handoff thresholds of an UMTS;

FIG. 6 is a flowchart of an embodiment of a method for adjusting handoff parameters;

FIG. 7 is a schematic diagram illustrating an embodiment of a simulation result; and

FIG. 8 is a flowchart of an embodiment of an example for setting and adjusting handoff thresholds.

### DESCRIPTION

Handoff control methods and related devices are provided.

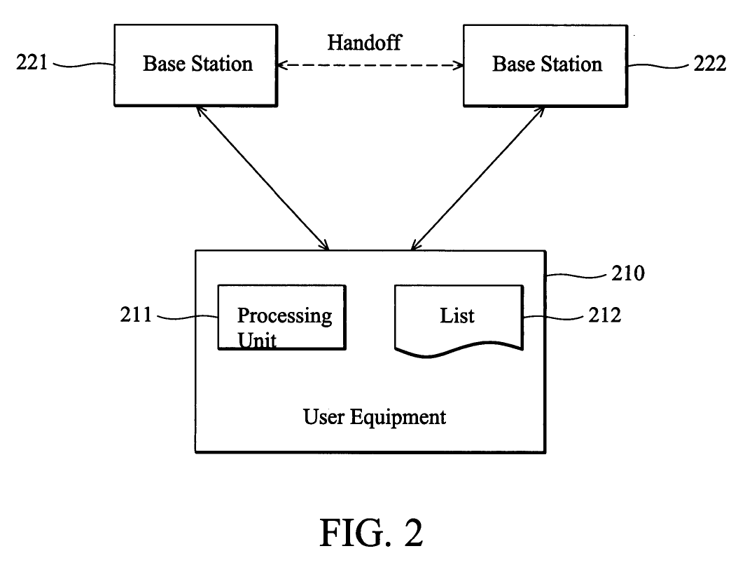

FIG. 2 is a schematic diagram illustrating an embodiment of user equipment. As shown in FIG. 2, the user equipment 210, such as a mobile phone, comprises a processing unit 211 performing the handoff control of the invention and other related operations. The user equipment 210 can measure the strength of pilots sent from a plurality of base stations, thus to acquire a list 212 of active base stations. The user equipment 210 can select handoff from among the active base stations (for example, base stations 221 and 222) according to the connection quality, and receive the communication service from the base station having the strongest pilot strength.

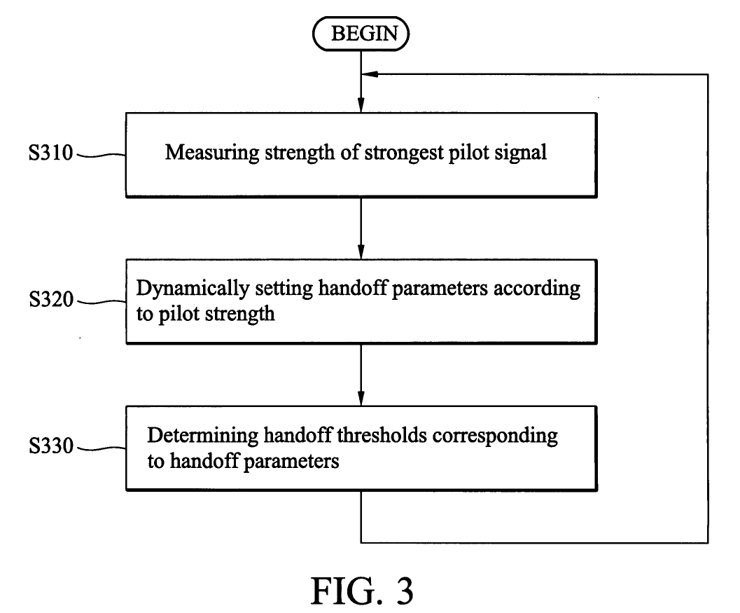

FIG. 3 is a flowchart of an embodiment of a method for setting handoff thresholds.

In step S310, user equipment 210 measures the strength of a first pilot signal in an active set. The first pilot signal is transmitted from a first base station currently having strongest pilot strength and providing services to the user equipment. In step S320, handoff parameters for handoff are dynamically set according to the strength of the first pilot signal, and in step S330, handoff thresholds are determined corresponding to the handoff parameters. The handoff parameters comprise reporting range, hysteresis, replacement hysteresis, and time-to-trigger (TtT) parameters. The handoff thresholds comprise add (Tr_add), drop (Tr_drop), and swap (Tr_swap) thresholds. The handoff thresholds are determined as follows.
Tr_add=Best_{—}Ss−AS_{—}Th+AS_T_{—}Hyst,
Tr_drop=Best_{—}Ss−AS_{—}Th−AS_{—}Th_Hyst,
Tr_swap=Worst_Old_{—}Ss+AS_{—}Rep_{—}Hyst,

Tr_add is the add threshold, Tr_drop is the drop threshold, Tr_swap is the swap threshold, Best_Ss is the strength of the strongest pilot signal in the active set, Worst_Old_Ss is the strength of the weakest pilot signal in the active set, As_Th is the reporting range, AS_Th_Hyst is the hysteresis, and the AS_Rep_Hyst is the replacement hysteresis.

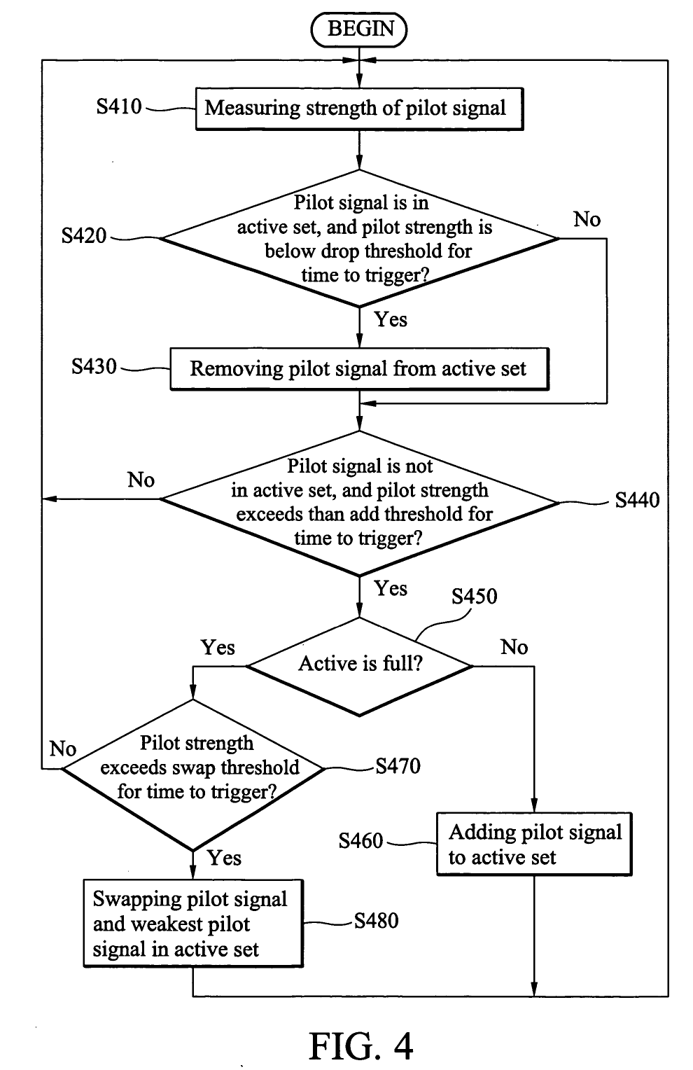

FIG. 4 is a flowchart of an embodiment of a handoff method.

In step S410, user equipment 210 measures the strength of a pilot signal. In step S420, it is determined whether the pilot signal is in the active set, and whether the strength of the pilot signal is below the drop threshold for the time to trigger (TtT). If not (No in step S420), the procedure goes to step S440. If so (Yes in step S420), in step S430, the pilot signal is removed from the active set. In step S440, it is determined whether the pilot signal is not in the active set, and whether the strength of the pilot signal exceeds the add threshold for the time to trigger (TtT). If not (No in step S440), the procedure returns to step S410. If so (Yes in step S440), in step S450, it is determined whether the active set is full. If not (No in step S450), in step S460, the pilot signal is added to the active set, and goes to step S410. If so (Yes in step S450), in step S470, it is determined whether the strength of the pilot signal exceeds the swap threshold for the time to trigger (TtT). If not (No in step S470), the procedure returns to step S410. If so (Yes in step S470), in step S480, the weakest pilot signal in the active set is removed therefrom and the pilot signal is added thereto.

In this embodiment, if the strength of the strongest pilot signal in the active set is weaker, the reporting range and the time to trigger can be set to smaller values. For example, if the strength of the strongest pilot signal in the active set exceeds −6 dB, the reporting range is set to 5 dB, and the time to trigger is set to 0.8 sec. If the strength of the strongest pilot signal in the active set is not smaller than −10 dB and not greater than −6 dB, the reporting range is set to 4 dB, and the time to trigger is set to 0.8 sec. If the strength of the strongest pilot signal in the active set is below −10 dB, the reporting range is set to 3 dB, and the time to trigger is set to 0.4 sec. In some embodiments, the hysteresis and the replacement hysteresis corresponding to different strength of the strongest pilot signal can be set to 1 dB.

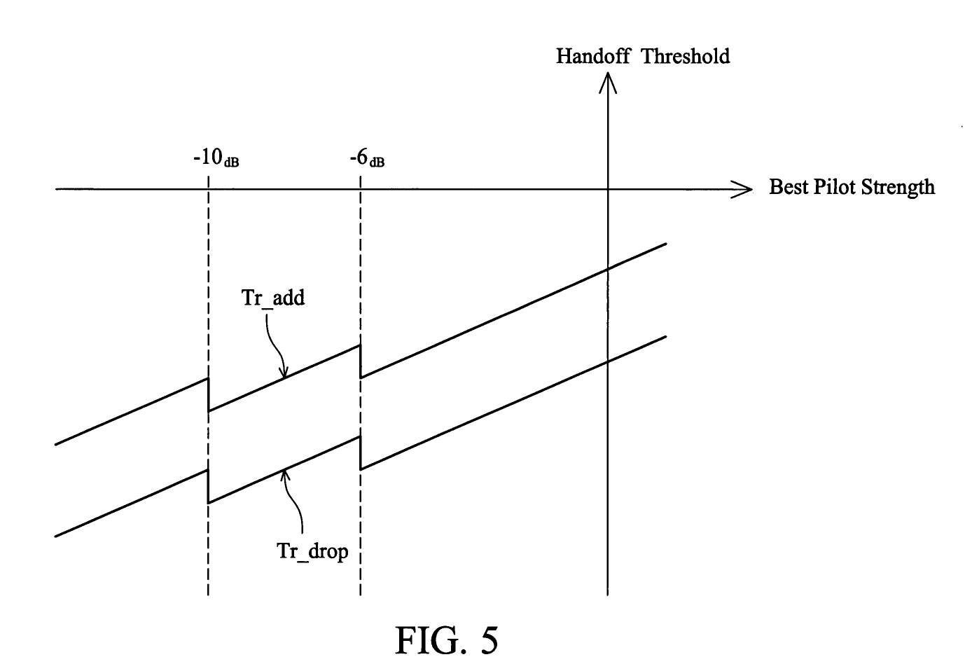

The increase of downlink total interference reduces the strength of individual aggregate Ec/Io and thus degrades connection quality. The invention dynamically sets the handoff thresholds according to the strength of the strongest pilot signal, to avoid excessive handoffs. FIG. 5 is a schematic diagram illustrating an embodiment of handoff thresholds of an UMTS. If the strength of the strongest pilot signal reduces, the handoff thresholds are increased. When the strength of the strongest pilot signal reduces, resulting in low connection quality, the time condition (time to trigger) that pilot signals must satisfy can be reduced, such that available pilot signals can be added to the active set as soon as possible, avoiding disconnection.

In addition to reducing the time condition, the handoff parameters can be further adjusted to improve connection quality when the strength of the strongest pilot signal is reduced.

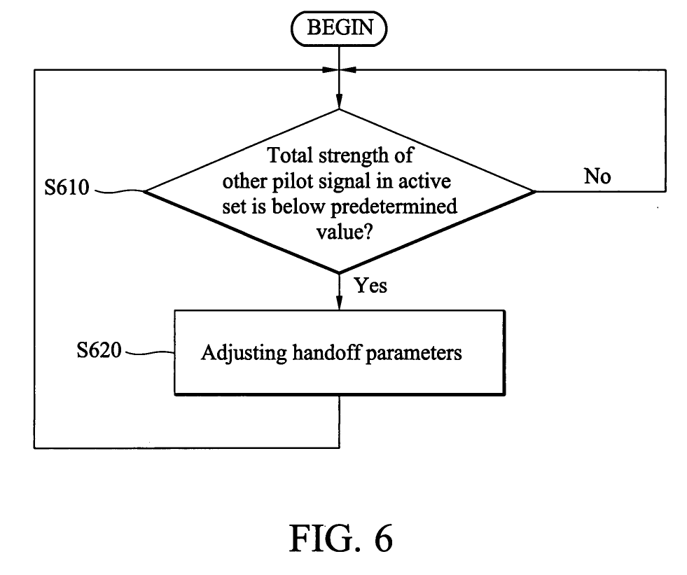

FIG. 6 is a flowchart of an embodiment of a method for adjusting handoff parameters.

In step S610, it is determined whether the total strength (Δ) of other pilot signals other than the strongest pilot signal in the active set is below a predetermined value, such as 2 dB. If not (No in step S610), the procedure remains at step S610. If so (Yes in step S610), in step S620, the handoff parameters are adjusted, and the procedure goes to step S610. The handoff parameters are adjusted by adding a predetermined value, such as 0.5 dB to the reporting range and the hysteresis, and setting the replacement hysteresis as an updated value, such as 0.5 dB. Since the reporting range and the hysteresis are simultaneously increased by a predetermined value, the add threshold is not changed, but the drop and swap thresholds are reduced, such that the weaker pilot signals in the active set will not be removed therefrom.

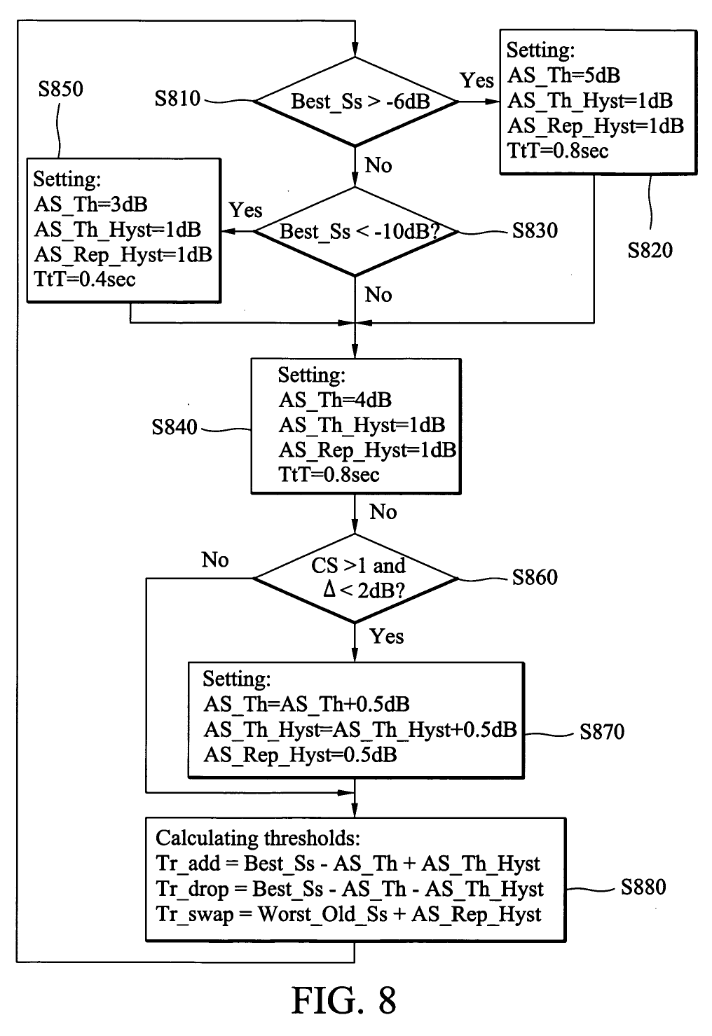

FIG. 8 is a flowchart of an embodiment of an example for setting and adjusting handoff thresholds.

In step S810, it is determined whether the strength of the strongest pilot signal (Best_Ss) in the active set exceeds −6 dB. If so, in step S820, the reporting range (AS_th) is set to 5 dB, the hysteresis (AS_Th_Hyst) is set to 1 dB, the replacement hysteresis (AS_Rep_Hyst) is set to 1 dB, and the time to trigger (TtT) is set to 0.8 sec. If not, in step S830, it is determined whether the strength of the strongest pilot signal (Best_Ss) in the active set is below −10 dB. If not, in step S840, the reporting range (AS_th) is set to 4 dB, the hysteresis (AS_Th_Hyst) is set to 1 dB, the replacement hysteresis (AS_Rep_Hyst) is set to 1 dB, and the time to trigger (TtT) is set to 0.8 sec. If so, in step S850, the reporting range (AS_th) is set to 3 dB, the hysteresis (AS_Th_Hyst) is set to 1 dB, the replacement hysteresis (AS_Rep_Hyst) is set to 1 dB, and the time to trigger (TtT) is set to 0.4 sec.

After the handoff parameters are dynamically set according to the strength of the strongest pilot signal, the handoff parameters can be further adjusted. In step S860, it is determined whether the number of pilot signals (CS) in the active set exceeds 1, and whether the total strength (Δ) of other pilot signals other than the strongest pilot signal in the active set is below 2 dB. If not, the procedure goes to step S880. If so, in step S870, the handoff parameters are adjusted by adding 0.5 dB to the reporting range (AS_Th=AS_Th+0.5 dB), adding 0.5 dB to the hysteresis (AS_Th_Hyst=AS_Th_Hyst+0.5 dB), and setting the replacement hysteresis to 0.5 dB (AS_Rep_Hyst=0.5 dB). In step S880, the handoff thresholds are determined corresponding to the adjusted handoff parameters, in which Tr_add=Best_Ss−AS_Th+AS_Th_Hyst, Tr_drop=Best_Ss—AS_Th−AS_Th_Hyst, and Tr_swap=Worst_Old_Ss+AS_Rep_Hyst. The procedure then returns to step S810 for further determination and adjustment.

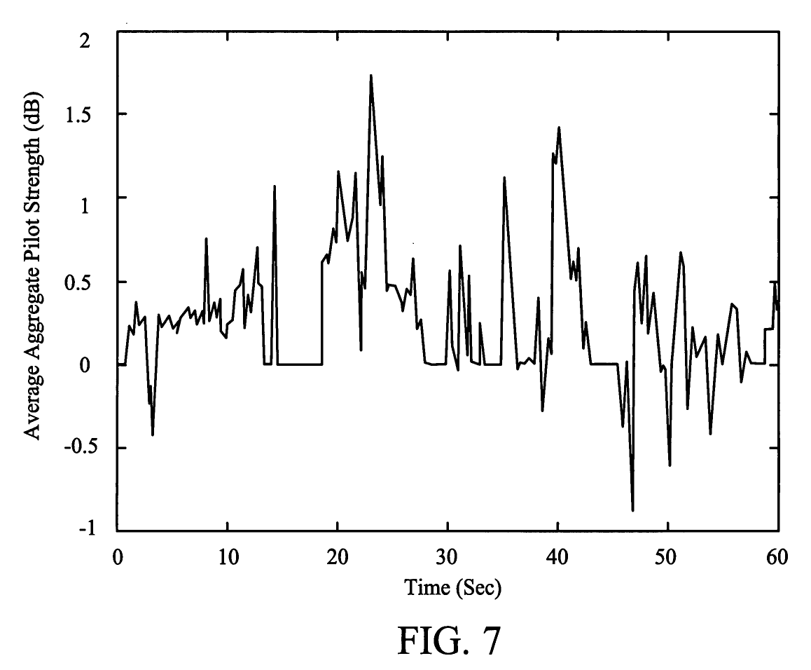

FIG. 7 is a schematic diagram illustrating an embodiment of a simulation result. In this simulation, 6 user equipment units are in 19 cells, each cell having 3 sectors. A center cell is used to study performance statistics. The Propagation model is Cellular Band, Hata Model. The Lognormal fading with a correction distance of 400 meters and the variance of 8 dB are used. Additionally, the handoff parameters, reporting range, hysteresis, replacement hysteresis, time to trigger, and the full size of active set in the UMTS are 5 dB, 1 dB, 3 dB, 0.8 sec, and 3, respectively. The sample time is 200 ms. As shown in FIG. 7, the difference of average aggregate pilot strength are almost positive, representing better pilot strength and connection quality can be obtained in the invention.

Handoff control methods, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A handoff control method, comprising:
measuring a strength of a first pilot signal in an active set by user equipment, in which the first pilot signal is transmitted from a first base station currently providing services to the user equipment;
dynamically setting at least one handoff parameter for handoff according to the strength of the first pilot signal; and
determining at least one handoff threshold corresponding to the handoff parameter.

2. The method of claim 1 wherein the handoff parameter comprises a reporting range, and the method comprises:
setting the reporting range to a second value if the strength of the first pilot signal exceeds a first value;
setting the reporting range to a fourth value if the strength of the first pilot signal is not smaller than a third value and not greater than the first value; and
setting the reporting range to a fifth value if the strength of the first pilot signal is below the third value,
in which the first value is not smaller than the third value, the second value is not smaller than the fourth value, and the fourth value is not smaller than the fifth value.

3. The method of claim 1 wherein the handoff parameter comprises a time to trigger, and the method comprises performing a predetermined operation corresponding to the handoff threshold for a second pilot signal if the strength of the second pilot signal satisfies the handoff threshold for the time to trigger.

4. The method of claim 3 wherein the handoff threshold comprises an add threshold, and the method comprises adding the second pilot signal to the active set if the second pilot signal is not in the active set, and the strength of the second pilot signal exceeds the add threshold for the time to trigger.

5. The method of claim 3 wherein the handoff threshold comprises a drop threshold, and the method comprises removing the second pilot signal from the active set if the second pilot signal is in the active set, and the strength of the second pilot signal is below the drop threshold for the time to trigger.

6. The method of claim 3 wherein the handoff threshold comprises a swap threshold, and the method comprises swapping the second pilot signal and a weakest third pilot signal in the active set if the active is full, the second pilot signal is not in the active set, and the strength of the second pilot signal exceeds the swap threshold for the time to trigger.

7. The method of claim 3 further comprising:
setting the time to trigger to a seventh value if the strength of the first pilot signal exceeds a sixth value;
setting the time to trigger to a ninth value if the strength of the first pilot signal is not smaller than an eighth value and not greater than the sixth value; and
setting the time to trigger to a tenth value if the strength of the first pilot signal is below the eighth value,
in which the sixth value is not smaller than the eighth value, the seventh value is not smaller than the ninth value, and the ninth value is not smaller than the tenth value.

8. The method of claim 1 further comprising adjusting the handoff parameters if the total strength of other pilot signals other than the first pilot signal in the active set is below a predetermined value.

9. The method of claim 8 wherein the handoff parameter comprises a reporting range and a hysteresis, and the method comprises adding a predetermined value to the reporting range and the hysteresis if the strength of other pilot signals is below the predetermined value.

10. The method of claim 8 wherein the handoff parameter comprises a replacement hysteresis having an original value, and the method comprises setting the replacement hysteresis to an updated value if the strength of other pilot signals is below the predetermined value, in which the updated value is below the original value.

11. A device for communication, comprising:
an active set comprising a first base station currently providing services to the device, and transmitting a first pilot signal; and
a processing unit dynamically setting at least one handoff parameter for handoff according to a strength of the first pilot signal, and determining at least one handoff threshold corresponding to the handoff parameter.

12. The device of claim 11 wherein the handoff parameter comprises a reporting range, and the processing unit further sets the reporting range to a second value if the strength of the first pilot signal exceeds a first value, sets the reporting range to a fourth value if the strength of the first pilot signal is not smaller than a third value and not greater than the first value, and sets the reporting range to a fifth value if the strength of the first pilot signal is below the third value, in which the first value is not smaller than the third value, the second value is not smaller than the fourth value, and the fourth value is not smaller than the fifth value.

13. The device of claim 11 wherein the handoff parameter comprises a time to trigger, and the processing unit further performs a predetermined operation corresponding to the handoff threshold for a second pilot signal if the strength of the second pilot signal satisfies the handoff threshold for the time to trigger.

14. The device of claim 13 wherein the handoff threshold comprises an add threshold, and the processing unit further adds the second pilot signal to the active set if the second pilot signal is not in the active set, and the strength of the second pilot signal exceeds the add threshold for the time to trigger.

15. The device of claim 13 wherein the handoff threshold comprises a drop threshold, and the processing unit further removes the second pilot signal from the active set if the second pilot signal is in the active set, and the strength of the second pilot signal is below the drop threshold for the time to trigger.

16. The device of claim 11 wherein the handoff threshold comprises a swap threshold, and the processing unit further swaps the second pilot signal and a weakest third pilot signal in the active set if the active set is full, the second pilot signal is not in the active set, and the strength of the second pilot signal exceeds the swap threshold for the time to trigger.

17. The device of claim 13 wherein the processing unit further sets the time to trigger to a seventh value if the strength of the first pilot signal exceeds a sixth value, sets the time to trigger to a ninth value if the strength of the first pilot signal is not smaller than an eighth value and not greater than the sixth value, and sets the time to trigger to a tenth value if the strength of the first pilot signal is below the eighth value, in which the sixth value is not smaller than the eighth value, the seventh value is not smaller than the ninth value, and the ninth value is not smaller than the tenth value.

18. The device of claim 11 wherein the processing unit further adjusts the handoff parameters if the total strength of other pilot signals other than the first pilot signal in the active set is below a predetermined value.

19. The device of claim 18 wherein the handoff parameter comprises a reporting range and a hysteresis, and the processing unit further adds a predetermined value to the reporting range and the hysteresis if the strength of other pilot signals is below the predetermined value.

20. The device of claim 18 wherein the handoff parameter comprises a replacement hysteresis having an original value, and the processing unit further sets the replacement hysteresis to an updated value if the strength of other pilot signals is below the predetermined value, in which the updated value is below the original value.
